(19) United States
(12) Patent Application Publication
(10) Pub. No.: US 2002/0169786 A1
(43) Pub. Date: Nov. 14, 2002

(54) Type-safe homogeneous linkage for heterogeneous smart pointers

(76) Inventor: Martin D. Richek, Houston, TX (US)

Correspondence Address: DANN DORFMAN HERRELL & SKILLMAN, SUITE 720, 1601 MARKET STREET, PHILADELPHIA, PA, 19103-2307, US

(21) Appl. No.: 10/079,928

(22) Filed: Feb. 19, 2002

Related U.S. Application Data
(60) Provisional application No. 60/269,232, filed on Feb. 16, 2001.
(60) Provisional application No. 60/271,526, filed on Feb. 26, 2001.

(51) Int. Cl. G06F 7/00

(52) U.S. Cl. 707/103 R

(57) ABSTRACT

A non-intrusive smart pointer for providing memory management and type-safe homogeneous linkage for heterogeneous smart pointers is provided. A linked list of smart pointers is provided to represent a reference count of an object pointed to by the smart pointers. A base common to all smart pointers is provided to permit pointers to different sub-objects of the same object to be members of a single ring. A class template for generating a different class of smart pointer for each class of object for which a smart pointer is used is provided. The class template provides member functions to generate smart pointer classes specific to the respective classes of objects controlled by the smart pointers to maintain type safety. In addition, member function templates of the class function are provided, to enable automatic conversion between smart pointers of different classes within the same class hierarchy.

### RELATED APPLICATIONS

This applications claims the benefit of U.S. Provisional Application Serial No. 60/269,232, filed on Feb. 16, 2001 and U.S. Provisional Application Serial No. 60/271,526 filed on Feb. 26, 2001, the entire contents of which are incorporated herein by reference.

### FIELD OF THE INVENTION

The present invention relates generally to a computer method for managing the lifetime of a memory-resident element, and more specifically to a framework for use in an object-oriented environment that provides type-safe homogeneous linkage for heterogeneous smart pointers.

### BACKGROUND OF THE INVENTION

A frequently encountered problem in object-oriented programming is the control of the lifetime of dynamically allocated objects. This problem shows up in two forms. The first is memory leak, where the memory assigned to dynamically allocated objects is not released to the system after that memory is no longer being used. Such failure to release unused memory creates hardware and software inefficiencies and can require more memory than otherwise needed, thus needlessly increasing hardware cost. More significantly, in more complex software applications where a multiplicity of objects are dynamically allocated, the failure to release the associated memory when the object is no longer needed will often result in run-time errors, i.e., program crashes.

The second problem is a dangling pointer, where reference is made to an object after its memory has been released to the system (i.e., the object is no longer available). Where a reference is made to a dangling pointer the run-time result is unpredictable and may result in an invalid value being returned, crashing of the program, or both.

Since many object-oriented programming languages, such as C++, do not inherently release unused memory or check for a dangling pointer condition, an added burden is imposed on the programmer to provide code to keep track of memory release and object lifetime. Adding such code to monitor these conditions produces a number of undesirable effects. First, providing additional code increases the program development cost, since the programmer must dedicate time to addressing such problems. As programs become larger and more complex, it also becomes more difficult to comprehensively and reliably provide code to keep track of memory release and eliminate the possibility of a dangling pointer. For example, in particularly large programs, multiple programmers may work on different code sections, in which case providing such additional code consistently and uniformly throughout the program can be difficult to achieve, and therefore can add significant development cost.

Second, the manner in which the additional code is implemented has the potential for decreasing the performance of the resulting program, as processor time must be spent executing the additional code. In addition, the additional code may necessitate added hardware, e.g., memory. Hence, there remains a need to provide program developers with programming tools that afford a convenient and efficient approach to control and monitor memory release and object lifetimes.

In addition, many software applications are already written in languages such as C++, including major commercial products such as database management programs, where the above problems have not been adequately addressed. Failure to address the problems yields software applications that run less efficiently and reliably than is otherwise possible. In many instances, the existing software applications which suffer from these problems are ones that are particularly complex and contain many lines of code. Consequently, an intrusive method of monitoring the memory usage is undesirable as it requires rewriting major portions of lengthy, complex code. Thus, there also remains a need for non-intrusive, retrofit programming tools that provide for efficient memory allocation and minimize performance cost. Moreover, in many instances, memory allocation relates to a number of pointers some of which may point not only to a particular object, but also to differently-typed sub-objects of the object. The pointers to sub-objects, like pointers to the object containing the sub-objects, also need to be monitored to avoid memory release problems and the dangling pointer condition. In addition, such monitoring needs to be maintained as pointers to differently-typed sub-objects are assigned to one another. Thus, there is a need for programming tools which also enable management of heterogeneous pointers.

### SUMMARY OF THE INVENTION

In accordance with the present invention, a computer-implemented method of memory management is provided. The method includes the step of providing a linked list comprising at least one smart pointer associated with a memory-resident element. As used herein, a smart pointer means a user-defined type that includes the behavior of a built-in pointer and adds additional functions. The linked list may take the form of a bi-directional, doubly-linked ring. The smart pointer includes a next pointer for pointing to a selected smart pointer, which may be a different smart pointer on the linked list or may be the selected smart pointer itself. The method includes the step of comparing the value of the memory location of a selected smart pointer giving up its association with the memory-resident element to the value of the next pointer of the selected smart pointer, to provide a determination whether the linked list contains only the selected smart pointer. If the value of the memory location of the selected smart pointer equals the value of the next pointer of the selected smart pointer, then the linked list comprises only the selected smart pointer. The method also provides the step of deleting the memory-resident element when the value of the memory location of a selected smart pointer equals the value of the next pointer of the selected smart pointer, whereby the memory assigned to the memory-resident element is released when no further reference can be made to the memory-resident element. In order to provide type-safety, the step of providing a common base to all types of smart pointers is provided by the method of the invention. The method includes the step of providing a function that provides automatic conversion between smart pointers of different classes in the same class hierarchy of the common base.

A memory-resident structure of an object-oriented programming environment arranged to manage the life-time of an object is also provided. The memory-resident structure includes a linked list comprising at least one smart pointer for keeping track of references to an object. The smart pointer includes a next pointer for pointing to a smart pointer on the linked list. The memory-resident structure also includes a function for deleting the object when the value of a selected next pointer equals the value of the memory location of the smart pointer in which the selected next pointer is included. The memory-resident structure includes a function that provides automatic conversion between smart pointers of different classes in the same class hierarchy.

### BRIEF DESCRIPTION OF THE DRAWINGS

The foregoing summary and the following detailed description of the preferred embodiments of the present invention will be best understood when read in conjunction with the appended drawings, in which:

FIG. 1 schematically illustrates a bi-directional ring of smart pointers having two members;

FIG. 2 schematically illustrates the ring of FIG. 1 with an additional smart pointer inserted into the ring;

FIG. 3 schematically illustrates the ring of FIG. 1 with one of the members removed from the ring; and

FIG. 4 schematically illustrates a flowchart of a function for managing a smart pointer which is giving up its object which includes a test for the condition that a ring has only a single-member.

### DETAILED DESCRIPTION OF THE INVENTION

One aspect of the invention relates to a linked list or ring of non-intrusive smart pointers each of which is associated with a particular memory-resident element. One or more linked lists or rings may be active at the same time during the running of a program, however each list or ring contains all smart pointers associated with a particular memory-resident element, including pointers that point directly to the element or to a sub-element of the element. The linked list or ring provides a structure which can be monitored to determine when the last smart pointer to a particular pointed-to memory-resident element expires, whereupon the element itself may be deleted to release the memory allocated to the element. Use of a linked list or ring provides non-intrusive monitoring of a memory-resident element without the need for extra memory allocation and release to provide the monitoring. The non-intrusive aspect of the smart pointer list of the present invention permits use of the smart pointer list in existing applications without intrusive revision of the application code.

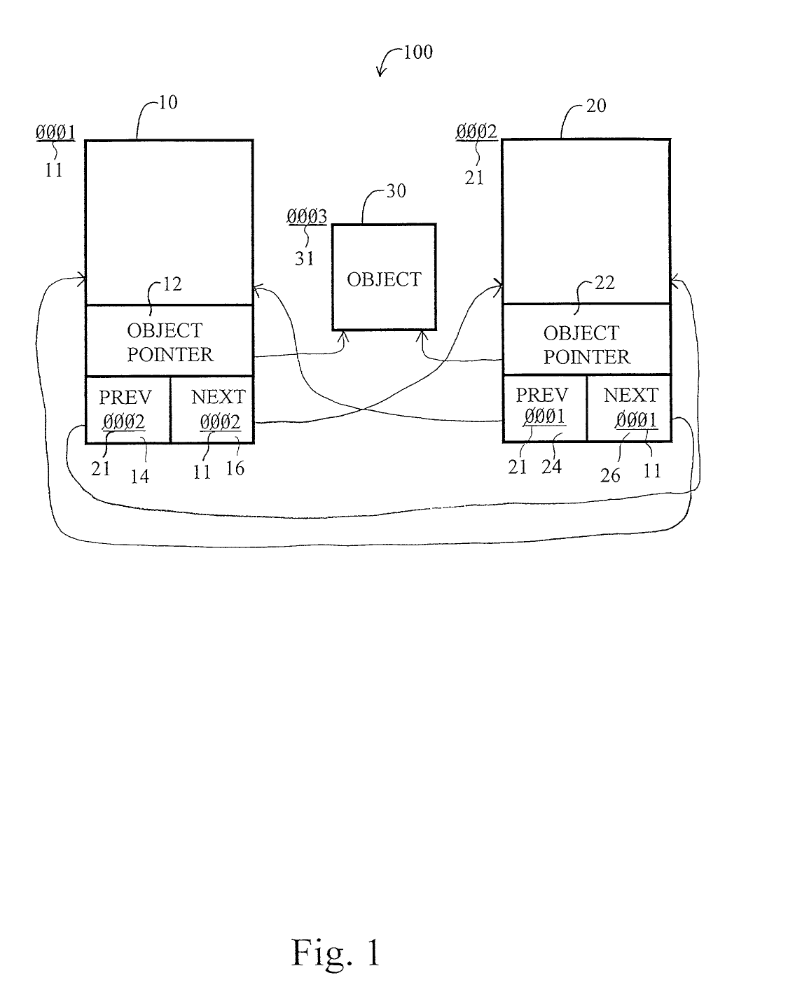

The linked list may be provided as either a singly-linked or doubly-linked list or ring. While a linear list may be used, a ring list can provide a performance improvement over a linear list by eliminating the need to test for the end-of-list condition. Thus, referring to FIG. 1, one specific embodiment of the present invention for use in an object-oriented environment provides a bi-directional, doubly-linked ring 100 to monitor smart pointers to a memory-resident object 30.

The ring 100 comprises one or more smart pointers, and in the particular case illustrated in FIG. 1, the ring 100 contains a first smart pointer 10 and a second smart pointer 20. Each smart pointer 10, 20 includes an object pointer 12, 22 that points to the same object 30. In order for a smart pointer to be a member of the ring 100, the smart pointer must point to the same object 30 or to a sub-object of that object 30. The first smart pointer 10, second smart pointer 20, and the pointed-to object 30 each has a respective memory address 11, 21, 31 associated therewith. In the case where the first and second smart pointers 10, 20 both point to the same object 30, the object pointers 12, 22 both contain the memory address 31 of the object 30, which, by way of example, has a value of 0003 as shown in FIG. 1.

Each smart pointer 10, 20 includes a “Next” pointer 16, 26 and “Previous” pointer 14, 24 for pointing to the next member of the ring 100 and the previous member of the ring 100, respectively. In particular, as shown in FIG. 1, the first smart pointer 10 includes a “Next” pointer 16 which points to the second smart pointer 20 and includes a “Previous” pointer 14 which points to the second smart pointer 20. In the case shown where there are only two smart pointers on the ring, the second smart pointer 20 is both the next member on the ring 100 after the first smart pointer 10 and is also the previous member on the ring 100 before the first smart pointer 10. Hence, the “Next” pointer 16 and the “Previous” pointer 14 of the first smart pointer 10 each contain the memory address 21 of the second smart pointer 20, which, by way of example, has a value of 0002 as shown in FIG. 1. In a similar fashion, the second smart pointer 20 includes a “Next” pointer 26 which points to the first smart pointer 10 and includes a “Previous” pointer 24 which points to the first smart pointer 10. Thus, the “Next” pointer 26 and the “Previous” pointer 24 of the second smart pointer 20 each contain the memory address 11 of the first smart pointer 10, which has an exemplary a value of 0001 as shown in FIG. 1. In the case where more than two smart pointers are present on the ring, the “Next” pointer and the “Previous” pointer of a particular smart pointer will point to different smart pointers on the ring.

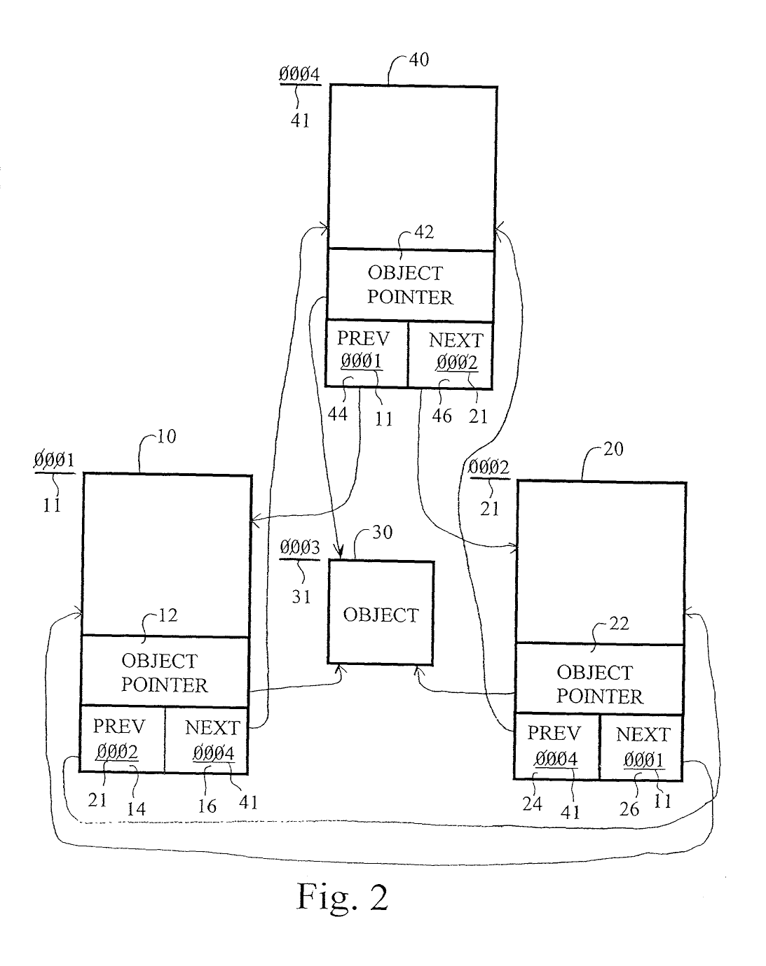

For example, with reference to FIG. 2, a three-member ring 100 is shown which is created by inserting a third smart pointer 40 between the first smart pointer 10 and the second smart pointer 20 of the ring 100 of FIG. 1. A smart pointer is added to the ring 100 when a smart pointer associated with the same object 30 is assigned or copied. All smart pointers associated with a particular object are located on the same ring to provide complete monitoring of all pointers to the particular object. Like the first and second smart pointers 10, 20, the third smart pointer 40 also contains an object pointer 42 that points to the object 30 or to a sub-object of object 30. To insert the third smart pointer 40 between the first smart pointer 10 and the second smart pointer 20, the “Next” pointer 16 of the first smart pointer 10 and the “Previous” pointer 24 of the second smart pointer 20 are each changed to point to the third smart pointer 40. Thus, the “Next” pointer 16 of the first smart pointer 10 and the “Previous” pointer 24 of the second smart pointer 20 each contain the memory address 41 of the third smart pointer 40, which, by way of example, has a value of 0004 as shown in FIG. 2. The third smart pointer 40 includes a “Next” pointer 46 which points to the second smart pointer 20 and includes a “Previous” pointer 44 that points to the first smart pointer 10. In a C++ embodiment of the invention, as provided in the Example below, the insertion operation of a smart pointer onto a ring is provided by the member functions void Attach (const PtrBase & other) const and void AttachX (const PtrBase & other) const. Attach and AttachX perform the same function from opposite frames of reference. Attach attaches this PtrBase to the ring of which the other PtrBase is a member. As used herein with reference to the C++ embodiment of the Example, the term “this” refers to a hidden pointer passed to each member function that points to the object for which the member function has been invoked. AttachX attaches the other PtrBase to the ring of which this PtrBase is a member. Since PtrBase is a base class that may be in use by different derived classes, the presence of both member functions allows ring insertion when one derived class may not have access to the PtrBase member functions of the other.

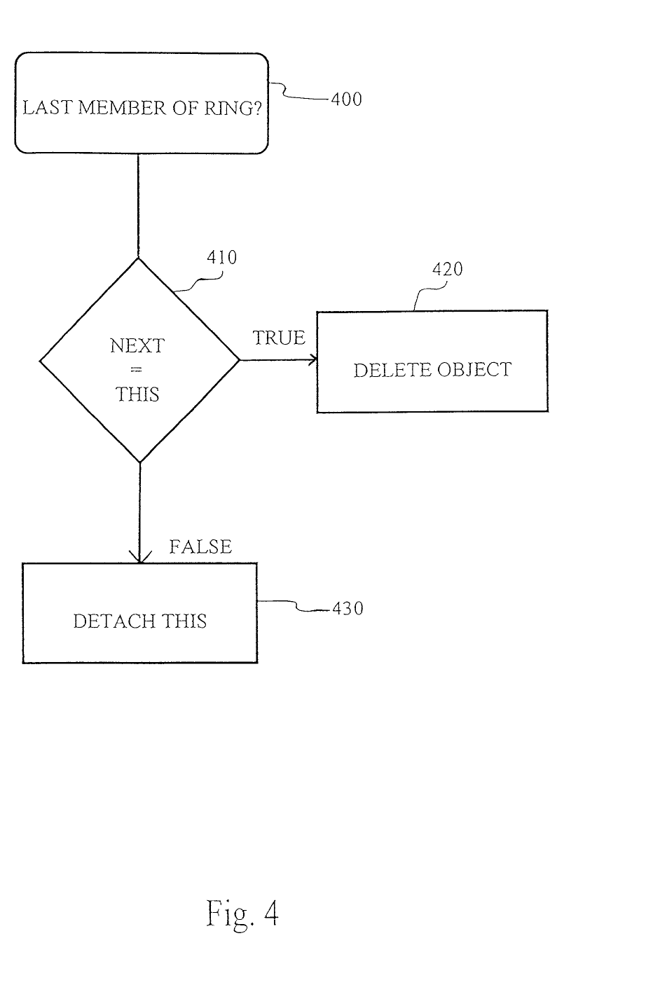

When a smart pointer gives up its object pointer—whether it is receiving a new object pointer or it is expiring—then, that smart pointer is removed from the ring of which it is a member. In particular, to know when an object is no longer needed and the object's memory should therefore be released, it is important to test whether the smart pointer giving up its object pointer is the last member of the ring. If the smart pointer is the last member of the ring, the object to which it points may be deleted. The “last member of the ring” test is illustrated in FIG. 4.

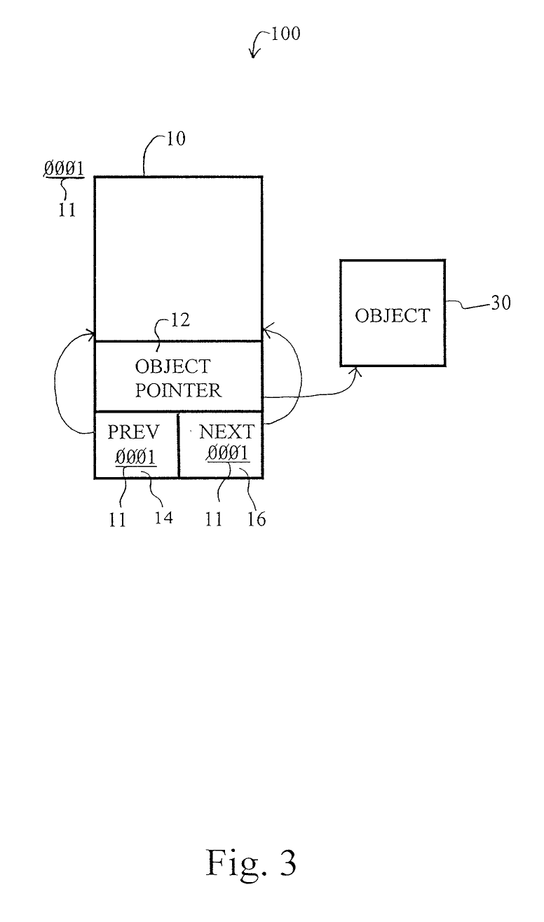

A smart pointer that is alone on a ring points to itself as both the next and the previous “members” of the ring, as illustrated in FIG. 3. That is, the “Next” pointer 16 and “Previous” pointer 14 of the first smart pointer 10 each point to the first smart pointer 10. Thus, the values of the “Next” pointer 16 and “Previous” pointer 14 are equal, and each contains the memory address of the smart pointer 10 to which it belongs. More importantly, a significant distinction exists between the “Next” and “Previous” pointer values of each smart pointer in the single-member ring 100 of FIG. 3 and the two-member ring 100 of FIG. 1. In the two-member ring 100, the “Next” pointer 16 and the “Previous” pointer of the each smart pointer contain the memory address of the other smart pointer. In contrast, for the single-member ring 100, the “Next” pointer 16 and the “Previous” pointer 14 of the first smart pointer 10 each contains the memory address of the smart pointer to which it belongs. Thus, while the values of the “Next” pointer 16 and the “Previous” pointer 14 are equal to each other in both the single-member ring and the two-member ring, the values of the “Next” pointer 16 and the “Previous” pointer 14 are equal to the address of the smart pointer to which they belong only when the ring 100 contains a single-member as shown in FIG. 3. Therefore, the test for a single-member ring, step 410 of FIG. 4, comprises comparing the value of either the “Next” pointer 16 or the “Previous” pointer 14 to the address of the smart pointer to which the “Next” pointer 16 and “Previous” pointer 14 belong, e.g., the first smart pointer 10. If the test for equality between the value of the “Next” pointer 16 and the address of the first smart pointer 10, as provided at step 410, is true, then the object 30 is deleted at step 420. In the C++ embodiment of the invention of the Example below, the test of step 410 is provided by the member function bool IsOnly ( ) const.

If the test of step 410 returns “false”, then the ring contains more than one smart pointer, and the smart pointer which is giving up its object pointer is removed from the ring. For example, if the ring contains three elements as shown in FIG. 2 and the smart pointer which is giving up its object pointer is the third smart pointer 40, then the third smart pointer 40 is removed from the ring 100 yielding the two-member ring shown in FIG. 1. The “Next” pointer 16 of the first pointer 10 and “Previous” pointer 24 of the second smart pointer 20 are set to point to the second smart pointer 20 and the first smart pointer 10, respectively, as explained above with reference to FIG. 1. In the C++ embodiment of the invention of the Example below, detaching a smart pointer from a ring is provided by the member function void Detach ( ) const.

A further aspect of the present invention relates to a framework for providing type-safe homogeneous linkage for heterogeneous smart pointers. The framework comprises a base common to all smart pointers and a template for managing inter-class assignment and inter-class conversion of smart pointers. All ring operations, such as those discussed above, are contained in the common base shared by all smart pointers. Providing a base common to all smart pointers is desirable in class-hierarchical programming environments, such as C++, where the derived pointer is typed, since provision of a common pointer base allows pointers to objects of different classes in a common class hierarchy that point to different sub-objects of the same object to be members of a single ring, providing a complete representation of all references to an object. Alternatively, in a language that does not allow a pointer to be typed, the pointer base can be part of the pointer rather than its base. One embodiment of the common base is provided in the Example below. Although the Example is written in C++ and is therefore discussed using C++ terminology, the subject matter and underlying concepts apply equally well to other object-oriented programming languages.

Referring now to the Example, the common base defines the attributes of a smart pointer which may be used in the bi-directional, doubly-linked ring embodiment disclosed above in reference to FIGS. 1-4. The attributes of the common base, PtrBase, include two pointers to PtrBase objects: a “Next” pointer, Next, and a Previous pointer, Prev. Next and Prev are used to maintain a bi-directional, doubly-linked ring of PtrBase objects whose derived pointers point to the same controlled object. Next and Prev are declared to be mutable, which allows them to be manipulated by the PtrBase even when the PtrBase is constant. Each PtrBase object points to the Next and Previous PtrBase object on the ring. In addition, the common base, PtrBase, includes the member functions used to construct and destruct ring members and manipulate the ring. In particular, constructor and destructor member functions are provided in the common base along with the attach, detach, and single-member test member functions described above. Further, a member function, size_t Refs ( ) const, is provided for returning a value representing the number of members on a ring, which can be useful in debugging situations, for example.

The framework also comprises a class template for generating a different class of smart pointer for each class of object for which a smart pointer is used. The class template provides member functions to generate smart pointer classes specific to the respective classes of objects controlled by the smart pointers, in order to maintain type safety. In particular, the member function templates provided by the class function provide automatic conversion between smart pointers to objects of different classes in a common class hierarchy when such smart pointers point to different sub-objects of the same object.

The class template, template<typename T>class Ptr : public PtrBase, is derived from PtrBase and generates a Ptr class specific to the type of the object being controlled. The sole attribute of a Ptr, T*TPtr, is the built-in pointer to the object. The template also provides a constructor, explicit Ptr (T*ptr), to set the built-in pointer to the value of ptr. The constructor is made explicit to prevent an implicit conversion of a built-in pointer to a smart pointer.

The class template Ptr provides for automatic conversion of pointers to objects of different classes in a common class hierarchy when such pointers are pointing to different sub-objects of the same object. In particular, the template Ptr provides constructor and assignment member function templates that accept as arguments built-in pointers and smart pointers to objects of different classes, and uses such member function templates to automatically perform the necessary casting on the built-in pointers.

To this end, Ptr includes a member function template, template<typename TT>Ptr (const Ptr<TT>& other), to provide a copy constructor with automatic conversion of a smart pointer to one sub-object to a smart pointer to another sub-object of the same object. This is one of the cases for which the common base, PtrBase, provides the ability for both smart pointers to belong to the same ring. This member function dynamically casts the other built-in pointer to this built-in pointer. Such a conversion will only be successful if the other built-in pointer and this built-in pointer point to objects of classes that are in the same class hierarchy and that are sub-objects of the same object. If the conversion is invalid, then this built-in pointer is assigned a value of zero and this PtrBase is initialized using the Reset member function. If, however, the conversion is valid, then this built-in pointer points to the same object as the other built-in pointer, and, accordingly, this PtrBase is attached to the ring associated with the other PtrBase.

Ptr also includes a member function template, template<typename TT>Ptr & operator=(const Ptr<TT>& other), to provide a copy assignment with automatic conversion of a smart pointer to one sub-object to a smart pointer to another sub-object of the same object. This member function dynamically casts the other built-in pointer to this built-in pointer. If the other built-in pointer is different from this built-in pointer, then this PtrBase is tested to determine if it is the only PtrBase on its ring. If this PtrBase is the only PtrBase on its ring, then the object pointed to by this built-in pointer is deleted; otherwise, this PtrBase is detached from its ring. If the conversion is invalid, then this built-in pointer is assigned a value of zero and this PtrBase is initialized using the PtrBase::Reset member function. If, however, the conversion is valid, then this built-in pointer points to the same object as the other built-in pointer, and, accordingly, this PtrBase is attached to the ring associated with the other PtrBase. In all cases, the member function concludes by returning a reference to this.

Further non-template member functions are provided to enable smart pointer operations integrated with ring management. For example, a destructor member function,˜Ptr ( ), is provided to delete the object to which a smart pointer points, when such smart pointer is the only member of its ring. If the smart pointer is not the only member of its ring, the smart pointer is detached from its ring. The destructor member function utilizes PtrBase::Is Only( ) and PtrBase::Detach( ). Similarly, a member function, void Delete ( ), is provided to delete the object to which a smart pointer points, when such smart pointer is the only member of its ring. Such member function operates in much the same way as the destructor member function, with the addition that the built-in pointer is set to zero.

A copy constructor member function, Ptr (const Ptr & other), is provided. The copy constructor member function copies the other built-in pointer to this built-in pointer. If this built-in pointer is zero, then this PtrBase is initialized using PtrBase::Reset( ). If this built-in pointer is not zero, then this PtrBase is attached to the ring associated with the other PtrBase using PtrBase::Attach( ).

Assignment of a built-in pointer to a smart pointer is provided by the member function Ptr & operator=(T*ptr). The assignment member function tests to see if the other built-in pointer is different from this pointer. If the two are different, the following steps are performed. First, before the assignment is made, this PtrBase is tested to see if it is the only PtrBase on its ring. If this PtrBase is the only PtrBase on its ring, then the object pointed to by this built-in pointer is deleted. If this PtrBase is not the only PtrBase on its ring, then this PtrBase is detached from its ring using the member function PtrBase::Detach( ) and is initialized using PtrBase::Reset( ). Second, this built-in pointer is assigned a copy of the other built-in pointer. Finally, in all cases, the member function returns a reference to this.

A copy assignment member function, Ptr & operator=(const Ptr & other), is also provided. The copy assignment member function tests to see if the other built-in pointer is different from this built-in pointer. If the two are different, the following steps are performed. First, before the assignment is made, this PtrBase is tested to see if it is the only PtrBase on its ring. If this PtrBase is the only PtrBase on its ring, then the object pointed to by this built-in pointer is deleted. If this PtrBase is not the only PtrBase on its ring, then this PtrBase is detached from its ring using the member function PtrBase::Detach( ). Second, this built-in pointer is assigned a copy of the other built-in pointer. If this built-in pointer has a value of a zero, then this PtrBase is initialized using PtrBase::Reset. If this built-in pointer does not have a value of zero, then this PtrBase is attached to the ring of the other PtrBase using PtrBase::Attach. Finally, in all cases, the member function returns a reference to this.

In addition, providing for the frequent need to mix the use of smart pointers in retrofit situations with built-in pointers, a member function, T*Remove ( ), is provided for removing a built-in pointer from the smart pointer environment. This member function converts a smart pointer to a built-in pointer without deleting the object to which the smart pointer points. First, the member function tests to determine if the smart pointer being removed is not the only pointer to its controlled object, which if true results in the member function returning zero. Otherwise, the member function returns a copy of the built-in pointer of the smart pointer and sets the built-in pointer of the smart pointer to zero.

The embodiment of the Example also enables using the smart pointer with C++ Standard Library collections by providing a member function, bool operator <(const Ptr & other) const, defining a “less-than” condition which safely and correctly translates into the “less-than” condition for the controlled objects. If this built-in pointer is zero and the other built-in pointer is not zero, then the less-than member function returns “true”. If this built-in pointer and the other built-in pointer are both not zero and the object to which this built-in pointer points is less than the object to which the other built-in pointer points, then the less-than member function returns “true”. In all other cases, the less-than member function returns “false”.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. For example, while the embodiments are described in reference to memory-resident elements, the invention also has application to non- memory-resident elements such as IO mapped elements. It should therefore be understood that this invention is not limited to the particular embodiments described herein, but is intended to include all changes and modifications that are within the scope and spirit of the invention as set forth in the claims.

### EXAMPLE

| | |
|---|---|
| // | mr_Ptr.hxx |

#ifndef mr_Ptr_hxx
#define mr_Ptr_hxx
#include <cstddef>
#include <iosfwd>
namespace mr
{

class PtrBase
{

mutable const PtrBase * Next, * Prev;

protected:

PtrBase ()
{}
˜PtrBase ()
{}
void Reset () const
{

Next = Prev = this;

}
void Attach (const PtrBase & other) const
{

Next = &other;
Prev = other.Prev;
Prev->Next = other.Prev = this;

}
void AttachX (const PtrBase & other) const
{

other.Attach (*this);

}
void Detach () const
{

Prev->Next = Next;
Next->Prev = Prev;

}

public:

bool IsOnly () const
{

return Next == this;

}
size_t Refs () const
{

size_t refs = 1;
for (const PtrBase * link = Next; link != this; link = link->Next)

++refs;

return refs;

}

};
template<typename T> class Ptr:public PtrBase
{

T * TPtr;

public:

Ptr ()

:TPtr (0)

{

Reset ();

}
explicit Ptr (T * ptr)

:TPtr (ptr)

{

Reset ();

}
template<typename TI> Ptr (const Ptr<TT> & other)

:TPtr (dynamic_cast<T *> (static_cast<TT *> (other)))

{

if (TPtr == 0)

Reset ();

else

Attach (other);

}
Ptr (const Ptr & other)

:TPtr (other.TPtr)

{

if (TPtr == 0)

Reset ();

else

Attach (other);

}
˜Ptr ()
{

if (IsOnly ())

delete TPtr;

else

Detach ();

}
Ptr & operator = (T * ptr)
{

if (TPtr != ptr)
{
if (IsOnly ())

delete TPtr;

else
{

Detach ();
Reset ();

}
TPtr = ptr;

}
return *this;

}
template<typename TT>Ptr & operator = (const Ptr<TT> & other)
{

T * tptr = dynamic_cast<T *> (static_cast<TT *> (other));
if (TPtr != tptr)
{

if (IsOnly ())

delete TPtr;

else

Detach ();

if ((TPtr = tptr) == 0)

Reset ();

else

Attach (other);

}
return *this;

}
Ptr & operator = (const Ptr & other)
{

if (TPtr != other.TPtr)
{

if (IsOnly ())

delete TPtr;

else

Detach ();

TPtr = other.TPtr;
if (TPtr == 0)

Reset ();

else

Attach (other);

}
return *this;

}
void Delete ()
{

if (IsOnly ())

delete TPtr;

else

{

Detach ();
Reset ();

}
TPtr = 0;

}
T * Remove ()
{

if (!IsOnly ())

return 0;

T * tptr = TPtr;
TPtr = 0;
return tptr;

}
T * operator -> () const
{

return TPtr;

}
T & operator * () const
{

return *TPtr;

}
operator T * () const
{

return TPtr;

}
bool operator < (const Ptr & other) const
{

if (TPtr == other.TPtr)

return false;

if (TPtr != 0 && other.TPtr != 0)

return *TPtr <*otherTPtr;

return TPtr == 0;

}

};

}
#endif // mr_Ptr_hxx

What is claimed is:

1. A computer-implemented method for performing memory management of an object in an object-oriented programming environment using smart pointers, comprising the steps of:
providing a base class common to all types of smart pointers;
providing at least one smart pointer comprising an object pointer for pointing to an object, the smart pointer having a next link for pointing to a subsequent smart pointer on a ring and a previous link for pointing to a previous smart pointer on the ring; and
providing a function for automatically converting a smart pointer to an object of a first class to a smart pointer to an object of a second class, wherein the first class and the second class share the common base class.

2. The method according to claim 1, comprising the steps of providing single member test for determining if a selected smart pointer is the only member of the ring and providing a deletion means for deleting the object if the selected smart pointer is determined to be the only member of the ring.

3. A computer-implemented method of memory management, comprising the steps of:
providing a smart pointer for association with a memory-resident element, the smart pointer including a next pointer;
providing an assignment means for assigning the next pointer to point to the smart pointer thereby creating a linked list comprising the smart pointer; and
providing a comparison means for comparing the value of the next pointer to the value of the memory location of the smart pointer in which the selected next pointer is included, whereby a determination can be made if the ring contains more than one smart pointer.

4. The method according to claim 3, wherein the method comprises the step of providing a common base to the smart pointer.

5. The method according to claim 3, wherein the element is an object in an object-oriented programming environment.

6. The method according to claim 5, wherein the smart pointer includes an object pointer for pointing to the object.

7. The method according to claim 3, wherein the linked list comprises a ring.

8. The method according to claim 3, wherein the smart pointer includes a previous pointer.

9. The method according to claim 8, comprising a step of providing an assignment means for assigning the previous pointer to point to the smart pointer, thereby creating a bi-directional, doubly-linked list.

10. The method according to claim 9, wherein the linked list comprises a ring.

11. The method according to claim 3, comprising a step of providing a deletion means for deleting the memory-resident element associated with the smart pointer if the value of the next pointer of the smart pointer is equal to the value of the memory location of the smart pointer in which the next pointer is included.

12. The method according to claim 3, wherein the smart pointer includes a first smart pointer, and wherein the method comprises the step of providing an attachment means for attaching a second smart pointer associated with the memory-resident element to the linked list.

13. A computer-implemented method of memory management, comprising the steps of:
providing a linked list comprising a smart pointer associated with a memory-resident element, the smart pointer including a next-pointer for pointing to the smart pointer; and
providing a comparison means for comparing the value of the memory location of the smart pointer to the value of the next-pointer of the smart pointer, to provide a determination whether the linked list contains only the smart pointer.

14. The method according to claim 13, comprising the step of providing a deletion means for deleting the memory-resident element when the value of the memory location of the smart pointer equals the value of the next-pointer of the smart pointer, whereby the memory assigned to the memory-resident element is released when no further reference can be made to the memory-resident element.

15. The method according to claim 13, wherein the element is an object in an object-oriented progranmnming environment.

16. The method according to claim 15, wherein the smart pointer includes an object pointer for pointing to the object.

17. The method according to claim 13, wherein the linked list comprises a ring.

18. The method according to claim 13, wherein the smart pointer includes a previous pointer.

19. The method according to claim 18, comprising a step of providing an assignment means for assigning the previous pointer to point to the smart pointer, thereby creating a bi-directional, doubly-linked list.

20. The method according to claim 19, wherein the linked list comprises a ring.

21. The method according to claim 13, comprising a step of providing a deletion means for deleting the memory-resident element associated with the smart pointer if the value of the next-pointer of the smart pointer is equal to the value of the memory location of the smart pointer in which the next-pointer is included.

22. The method according to claim 13, wherein the smart pointer includes a first smart pointer, and wherein the method comprises the step of providing an attachment means for attaching a second smart pointer associated with the memory-resident element to the linked list.

23. A computer-implemented method of memory management, comprising the steps of:
providing a linked list comprising a first smart pointer and a second smart pointer each associated with a memory-resident element, the first smart pointer including a first next-pointer for pointing to the second smart pointer and the second smart pointer including a second next-pointer for pointing to the first smart pointer; and
providing a comparison means for comparing the value of the memory location of a selected smart pointer giving up its association with the memory-resident element to the value of the next-pointer of the selected smart pointer, to provide a determination whether the linked list contains only the selected smart pointer.

24. The method according to claim 23, comprising the step of providing a deletion means for deleting the memory-resident element when the value of the memory location of the selected smart pointer equals the value of the next-pointer of the selected smart pointer, whereby the memory assigned to the memory-resident element is released when no further reference can be made to the memory-resident element.

25. The method according to claim 23, wherein the linked list comprises a ring.

26. The method according to claim 23, wherein the first smart pointer and the second smart pointer each include a previous pointer.

27. The method according to claim 26, comprising a step of providing an assignment means for assigning the previous pointer of the first smart pointer to point to the second smart pointer and for assigning the previous pointer of the second smart pointer to point to the first smart pointer, thereby creating a bidirectional, doubly-linked list.

28. The method according to claim 27, wherein the linked list comprises a ring.

29. The method according to claim 23, comprising a step of providing a deletion means for deleting the memory-resident element associated with the selected smart pointer if the value of the next-pointer of the selected smart pointer is equal to the value of the memory location of the selected smart pointer.

30. The method according to claim 23, comprising the step of providing an attachment means for attaching a third smart pointer associated with the memory-resident element to the linked list.

31. The method according to claim 23, comprising the step of providing a common base to the smart pointers.

32. The method according to claim 23, wherein the element is an object in an object-oriented programmning environment.

33. The method according to claim 32, wherein the first smart pointer and the second smart pointer each include an object pointer for pointing to the object.

34. The method according to claim 32, wherein the first smart pointer is associated with a first object of a first class and the second smart pointer is associated with a second object of a second class, and wherein the method comprises the step of providing a conversion means for providing automatic conversion between the first smart pointer and the second smart pointer.
